(19) United States
(12) Patent Application Publication
(10) Pub. No.: US 2012/0135755 A1
(43) Pub. Date: May 31, 2012

(54) APPARATUS AND METHOD FOR PROVIDING CONTENTS SERVICES

(75) Inventors: Hoon Ki LEE, Daejeon (KR); Jong Hoon Lee, Daejeon (KR); Jung Tae Kim, Daejeon (KR); Eui Hyun Paik, Daejeon (KR)

(73) Assignee: Electronics and Telecommunications Research Institute, Daejeon (KR)

(21) Appl. No.: 13/301,465

(22) Filed: Nov. 21, 2011

(30) Foreign Application Priority Data
Nov. 25, 2010 (KR) 10-2010-0117989

(51) Int. Cl. H04W 4/02; H04W 60/00

(52) U.S. Cl. 455/456.2; 455/456.3

(57) ABSTRACT

Provided are an apparatus and a method of dynamic radar for providing an immediate service according to a user's location on the basis of a location where a user is positioned and a social relationship with other users. The present invention allows a user to retrieve desired information and receive a necessary service by providing an environment to dynamically execute a location-based service to the user through a dynamic radar and allows a provider providing a service and the user to form a direct community. According to the present invention, the user can retrieve various information such as surrounding events or a digital community through a radar when the user is positioned at a predetermined location and configure an immediate service execution environment by installing the necessary service directly in a terminal.

### CROSS-REFERENCE TO RELATED APPLICATIONS

This application claims priority to and the benefit of Korean Patent Application No. 10-2010-0117989 filed in the Korean Intellectual Property Office on Nov. 25, 2010, the entire contents of which are incorporated herein by reference.

### TECHNICAL FIELD

The present invention relates to an apparatus and a method for providing a contents service. More particularly, the present invention relates to an apparatus and a method for providing a content service under a social network service (SNS) environment.

### BACKGROUND

Services provided by predetermined providers such as a location-based information providing service, a knowledge searching service, a social networking service, and the like make up the main part of a known social network service (SNS). In the known social network service, a service execution application is installed in a terminal to receive a service, in general. Since most services are provided through a web store which communication providers provide, the social network service cannot help being dependent on the providers. Therefore, a dynamic service providing method of easily providing a service regardless of the providers is requested to general service providers (SP).

Further, most location-based services merely provide search information at a user's current location or provide related information to a push service. Accordingly, it is difficult to retrieve various services which can be provided on the basis of the user's current location or dynamically execute a selected service through the known social network service.

### SUMMARY

The present invention has been made in an effort to provide an apparatus and a method for providing a contents service that can provide various services by tracking a service and an event which can be shared through a dynamic service radar (DSR) on the basis of positional relationship information and social relationship information based on a user's current location and allowing a dynamic execution environment of the service to be shared.

An exemplary embodiment of the present invention provides an apparatus for providing a contents service, including: a location acquiring unit acquiring a current location value of a user terminal accessed by a user; an event tracking unit dynamically tracking events based on the acquired location value; and a contents service providing unit providing a contents service associated with an event selected among the tracked events.

The event tracking unit may include: an event extracting portion extracting events associated with a location determined by the acquired location value whenever the location value is acquired; and an event transmitting portion transmitting the extracted events to the user terminal associated with the acquired location value in real time.

The apparatus may further include a shared information generating unit generating execution environment sharing information for sharing an execution environment of the contents service on the basis of a profile defining the execution environment for each contents service, wherein the contents service providing unit may provide the contents service together with the execution environment sharing information associated with the corresponding contents service at the time of providing the contents service. The apparatus may further include a shared information determining portion determining one piece of execution environment sharing information on the basis of information regarding the user terminal or information regarding the service environment when execution environment sharing information associated with the corresponding contents service is at least two.

The location acquiring unit may additionally acquire location values of interested-party terminals accessed by interested parties having the social relationship with the user and may further include: an interested party extracting unit extracting interested parties positioned within a predetermined distance from the user on the basis of the location values of the interested-party terminals; and a community service providing unit providing a community service with which the extracted interested parties and the user are commonly associated.

The contents service providing unit may include: an event selecting portion selecting a predetermined event by user input among the tracked events; an access information processing portion transmitting access information of the user terminal to a provider server which registers the selected event; a first determining portion determining whether a content associated with the selected event is present; a second determining portion determining whether the contents service is provided on the basis of user input depending on the provided information in the case in which the content associated with the selected event is present, when information regarding the event is provided to the user terminal by the provider server; a user terminal analyzing portion analyzing the user terminal in the case in which the contents service is provided; and an execution environment processing portion transmitting information regarding the service execution environment to the user terminal at the time of transmitting the contents service when the user terminal is analyzed as a terminal which can execute the service.

The apparatus may further include an event registering unit registering events, wherein the event registering unit may include: an event registration request processing portion receiving an event registration request from a provider computer which the provider accesses; an event registration information generating portion requesting event registration information for registering events to the provider computer when the event registration request is received and generating the received event registration information in an event profile format when the event registration information by the request is received; a service registration judging portion inquiring whether a contents service to be registered simultaneously at the time of registering the events is present and judging whether the contents service is registered on the basis of a reply to the inquiry; and a registration portion registering the events so as to be dynamically tracked on of the location values of the interested-party terminals; and providing a community service with which the extracted interested parties and the user are commonly associated.

The providing of the contents service may include: selecting a predetermined event by user input among the tracked events; transmitting access information of the user terminal to a provider server which registers the selected event; determining whether a content associated with the selected event is present; determining whether the contents service is provided on the basis of user input depending on the provided information in the case in which the content associated with the selected event is present, when information regarding the event is provided to the user terminal by the provider server; analyzing the user terminal in the case in which the contents service is provided; and transmitting information regarding the service execution environment to the user terminal at the time of transmitting the contents service when the user terminal is analyzed as a terminal which can execute the service.

The method may further include registering events, wherein the registering of the events may include: receiving an event registration request from a provider computer which the provider accesses; requesting event registration information for registering events to the the basis of the generated event registration information. The event registering unit may further include: a contents service registration information generating portion requesting the contents service registration information for registering the contents service to the provider computer in the case in which the contents service to be registered is present and generating the received contents service registration information in a package registration profile format when the contents service registration information by the request is received; and a terminal information generating portion generating terminal information regarding a terminal which can execute the contents service, wherein the registration portion may register the events so as to be dynamically tracked on the basis of the generated contents service registration information and the generated terminal information.

Another exemplary embodiment of the present invention provides a method for providing a contents service, including: acquiring a current location value of a user terminal accessed by a user; dynamically tracking events based on the acquired location value; and providing a contents service associated with an event selected among the tracked events.

The tracking of the event may include: extracting events associated with a location determined by the acquired location value whenever the location value is acquired; and transmitting the extracted events to the user terminal associated with the acquired location value in real time.

The method may further include generating execution environment sharing information for sharing an execution environment of the contents service on the basis of a profile defining the execution environment for each contents service, wherein in the providing of the contents service, the execution environment sharing information associated with the corresponding contents service may also be provided together with the contents service at the time of providing the contents service. The method may further include determining one piece of execution environment sharing information on the basis of information regarding the user terminal or information regarding the service environment when execution environment sharing information associated with the corresponding contents service is at least two.

In the acquiring of the location, location values of interested-party terminals accessed by interested parties having the social relationship with the user may be additionally acquired and the acquiring of the location may further include: extracting interested parties positioned within a predetermined distance from the user on the basis provider computer when the event registration request is received and generating the received event registration information in an event profile format when the event registration information by the request is received; inquiring whether a contents service to be registered simultaneously at the time of registering the events is present and judging whether the contents service is registered on the basis of a reply to the inquiry; and registering the events so as to be dynamically tracked on the basis of the generated event registration information. The registering of the events may further include: requesting the contents service registration information for registering the contents service to the provider computer in the case in which the contents service to be registered is present and generating the received contents service registration information in a package registration profile format when the contents service registration information by the request is received; and generating terminal information regarding a terminal which can execute the contents service, wherein in the registering, the events may be registered so as to be dynamically tracked on the basis of the generated contents service registration information and the generated terminal information.

According to exemplary embodiments of the present invention, the following effects can be provided by dynamically tracking a service on the basis of positional relationship information and social relationship information based on a user's current location through a dynamic service radar (DSR) and sharing a dynamic service execution environment required to execute a service. First, various services can be immediately provided to a user. Second, since a web application does not need to be downloaded from a web store, it is possible to be free from a provider-dependent service. Third, when a user moves out of a predetermined range of a service providing area, the service is automatically deactivated and unnecessary service installation can be prevented. Fourth, time and costs consumed to construct a service execution environment can be saved.

### BRIEF DESCRIPTION OF THE DRAWINGS

FIG. 1 is a schematic block diagram of a contents service providing apparatus according to an exemplary embodiment of the present invention;

FIG. 2 is a block diagram showing the internal configuration of a contents service providing apparatus in detail;

FIG. 3 is a configuration diagram of a dynamic radar management system for an immediate service based on positions and social relationships;

FIG. 4 is a diagram showing a DB schema structure configuring a dynamic radar system for an immediate service based on positions and social relationships;

FIG. 5 is a flowchart showing a contents service providing method according to an exemplary embodiment of the present invention; and

FIG. 6 is a flowchart of a dynamic radar system management function for an immediate service based on positions and social relationships.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention. Hereinafter, the exemplary embodiment of the present invention will be described, but it will be understood to those skilled in the art that the spirit and scope of the present invention are not limited thereto and various modifications and changes can be made.

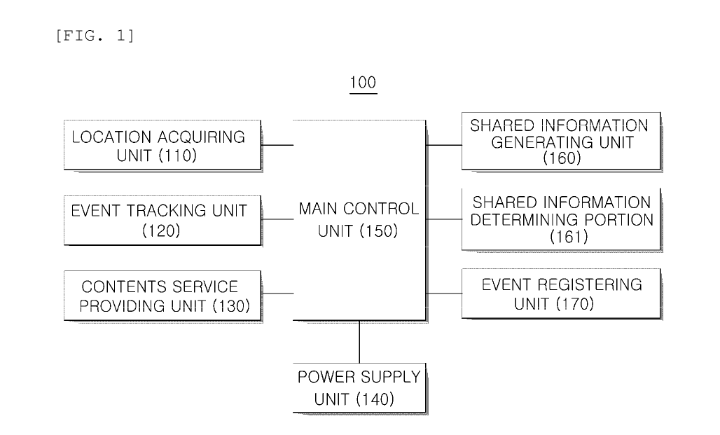

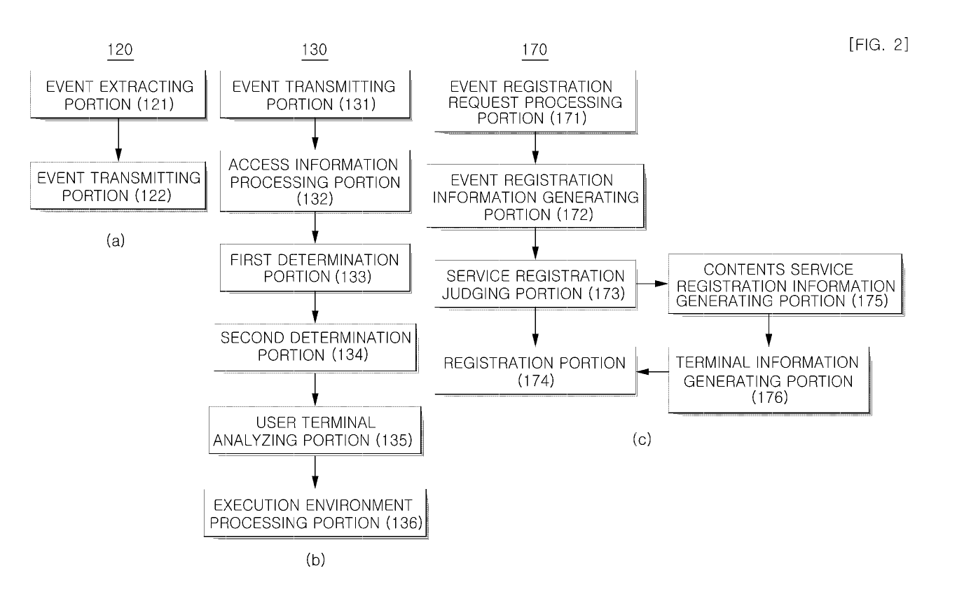

FIG. 1 is a schematic block diagram of a contents service providing according to an exemplary embodiment of the present invention. FIG. 2 is a block diagram showing the internal configuration of a contents service providing apparatus in detail. The following description refers to FIGS. 1 and 2.

Referring to FIG. 1, the contents service providing apparatus 100 includes a location acquiring unit 110, an event tracking unit 120, a contents service providing unit 130, a power supply unit 140, and a main control unit 150.

In the exemplary embodiment, the contents service providing apparatus 100 is a dynamic service radar (DSR) apparatus for an immediate service providing various pieces of information to a user by retrieving positional information and event information in real time through user's positional relationship information and social relationship information and sharing a service execution environment through dynamically interlocking a required service under a social network service (SNS) environment.

The location acquiring unit 110 acquires a current location value of a user terminal which the user accesses.

The event tracking unit 120 dynamically tracks events based on the acquired location value. User's surrounding information can be provided to the user terminal by considering a general radar tracking technique in the exemplary embodiment. In consideration of this point, the event tracking unit 120 includes an event extracting portion 121 and an event transmitting portion 122 as shown in FIG. 2A. In the radar tracking technique, at the time of determining the location of a target, when radio waves are transmitted and thereafter, the radio waves are returned as reflected waves by the target, the radio waves are received so as to determine the location of the target. In consideration of this point, the event extracting portion 121 and the event transmitting portion 122 recognizes the location value of the user terminal as event request information to process the location value.

In detail, the event extracting portion 121 extracts events associated with a location determined by the acquired location value whenever the location value is acquired and the event transmitting portion 122 transmits the extracted events to the user terminal associated with the acquired location value in real time.

The contents service providing unit 130 provides a contents service associated with an event selected from the tracked events. In order to perform such a function, the contents service providing unit 130 includes an event selecting portion 131, an access information processing portion 132, a first determining portion 133, a second determining portion 134, a user terminal analyzing portion 135, and an execution environment processing portion 136 as shown in FIG. 2B. The event selecting portion 131 selects a predetermined event by user input among the tracked events. The access information processing portion 132 transmits access information of the user terminal to a provider server which registers the selected event. The first determining portion 133 determines whether a content associated with the selected event is present. In the case in which the content associated with the selected event is present, when information regarding the event is provided to the user terminal by the provider server, the second determining portion 134 determines whether the contents service is provided on the basis of user input depending on the provided information. In the case in which the contents service is provided, the user terminal analyzing portion 135 analyzes the user terminal. When the user terminal is analyzed as a terminal which can execute the service, the execution environment processing portion 136 transmits information regarding the service execution environment to the user terminal at the time of transmitting the contents service.

The power supply unit 140 supplies power to each of the units constituting the contents service providing apparatus 100.

The main control unit 150 controls an overall operation of each of the units constituting the contents service providing apparatus 100.

In the exemplary embodiment, the contents service providing apparatus 100 may further include a shared information generating unit 160. The shared information generating unit 160 generates execution environment sharing information for sharing an execution environment of the contents service on the basis of a profile defining the execution environment for each contents service. According to such a function of the shared information generating unit 160, the contents service providing unit 130 may provide the contents service together with the execution environment sharing information associated with the corresponding contents service at the time of providing the contents service. The shared information generating unit 160 may generate a virtual space for sharing the execution environment.

Further, the contents service providing apparatus 100 may further include a shared information determining portion 161. The shared information determining portion 161 determines one piece of execution environment sharing information on the basis of information regarding the user terminal or information regarding the service environment when execution environment sharing information associated with the corresponding contents service is at least two. The shared information determining portion 161 may allow the user to set an optimal execution environment according to a terminal characteristic, a service environment, a service characteristic, and the like.

The contents service providing apparatus 100 may provide a multiparty interaction service by analyzing positional information of people having social relationship with the user. In consideration of this point, the location acquiring unit 110 may additionally acquire location values of interested-party terminals accessed by interested parties having the social relationship with the user. In this case, the contents service providing apparatus 100 may further include an interested party extracting unit and a community service providing unit. The interested party extracting unit extracts interested parties positioned within a predetermined distance from the user on the basis of the location values of the interested-party terminals. The community service providing unit provides a community service with which the extracted interested parties and the user are commonly associated.

The contents service providing apparatus 100 may further include an event registering unit 170. The event registering unit 170 registers events. In order to perform such a function, the event registering unit 170 includes an event registration request processing portion 171, an event registration information generating portion 172, a service registration judging portion 173, and a registration portion 174. The event registration request processing portion 171 receives an event registration request from a provider computer which the provider accesses. The event registration information generating portion 172 requests event registration information for registering events to the provider computer when the event registration request is received and thereafter, when the event registration information by the request is received, the event registration information generating portion 172 generates the received event registration information in an event profile format. The service registration judging portion 173 inquires whether a contents service to be registered simultaneously at the time of registering the events is present and judges whether the contents service is registered on the basis of a reply to the inquiry.

The registration portion 174 registers the events so as to be dynamically tracked on the basis of the generated event registration information. Meanwhile, the event registering unit 170 may further include a contents service registration information generating portion 175 and a terminal information generating portion 176. In the case in which the contents service to be registered is present, the contents service registration information generating portion 175 requests the contents service registration information for registering the contents service to the provider computer and when the contents service registration information by the request is received, the contents service registration information generating portion 175 generates the received contents service registration information in a package registration profile format. The terminal information generating portion 176 generates terminal information regarding a terminal which can execute the contents service. In the case in which the event registering unit 170 further includes the service registration information generating portion 175 and the terminal information generating portion 176, the registration portion 174 may register the events so as to be dynamically tracked on the basis of the generated contents service registration information and the generated terminal information.

Next, an exemplary embodiment associated with the configuration of the contents service providing apparatus 100 will be described.

A dynamic radar apparatus for an immediate service on the basis of positional/social relationship which is proposed as an exemplary embodiment provides a social network service by sharing a radar function for immediately collecting services and information events according to a user's location by considering user's positional/social relationship and an execution environment required to execute the service. Further, the dynamic radar apparatus not only receives limited information but also dynamically tracks and provides a service provided within a space where a user is present by a previously installed application. Further, the dynamic radar apparatus tracks information such as diversified services and events through a dynamic radar and when desired information is retrieved, the dynamic radar apparatus enables a service provided only at a current location to be dynamically shared by sharing an execution environment where the desired information can be serviced.

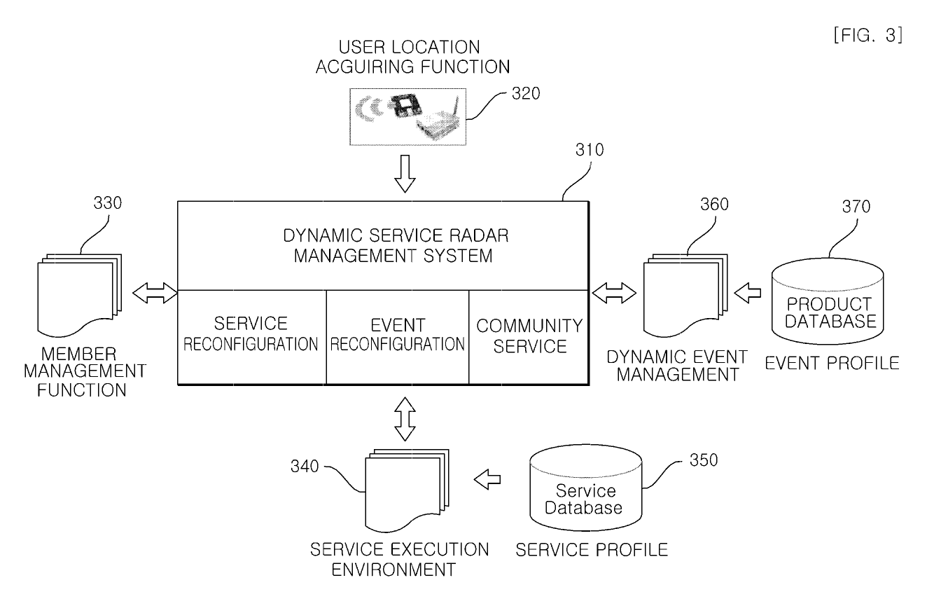

FIG. 3 is a configuration diagram of a dynamic radar management system for an immediate service based on positions and social relationships. This configuration diagram takes charge of analyzing surrounding information which can be immediately serviced on the basis of a user's location and social relationship between users and generating a virtual space so as for the user to share a dynamic execution environment for executing his/her desired service.

A user location management function 320 collects basic information through wired and wireless communication networks such as a GPS, WIFI, and the like which most mobile terminals provide. In the exemplary embodiment, user's positional information may be collected through various methods according to hardware characteristics of the terminals. The user location management function 320 corresponds to the location acquiring unit 110 of FIG. 1.

A dynamic services radar management system 310 analyzes serviceable information by analyzing user's current positional information to provide user's surrounding information through radar tracking. The dynamic service radar management system 310 is largely constituted by three functional elements such as service reconfiguration, event reconfiguration, and community service.

The user location management function 320 and a member management function 330 analyzes positional information of a current member and positional information with persons having the social relationship with the current member. Most services become activated starting from the member, and information retrieval and interuser interaction are performed through the services. The member management function 330 collects and manages current state information of each member for establishing a service/an event/a relationship.

A service execution environment 340 manages profiles defining features or execution environment elements of various services and constructs a series of information execution modules which can share the execution environment through a service profile 350. The service execution environment 340 selects a service based on a user's positional relationship through a service radar and establishes an optimal environment in the user terminal by dynamically downloading the service execution environment module suitable for the feature of the terminal in order to provide the selected service through the terminal. An environment in which an optimal immediate service execution environment can be made is provided by managing the terminal characteristic of the user, the service environment, the service characteristic, and the like through the service profile 350. Most web services provides necessary information through a central management system, while in the exemplary embodiment, service providers (SPs) provide diversified events which may immediately occur to only a user who accesses on the basis of a surrounding environment and provides an environment in which the events can be arbitrarily registered. The service execution environment 340 corresponds to the contents service providing unit 130 and the shared information generating unit 160 of FIG. 1.

A dynamic event management 360 may provide information to a user which exists within a predetermined location or domain in order to provide various event information to the user within a short time. Such a function transfers optimal information to a user who needs an event by inputting various information according to the service characteristic at the time of registering the event. In the case in which the user is positioned at a predetermined location and at a predetermined domain, the user may receive the event from various providers which want to transfer information. The event information may be immediately provided to the user as information providers manage information regarding an event profile 370 in real time. The dynamic event management 360 corresponds to the event tracking unit 120 of FIG. 1.

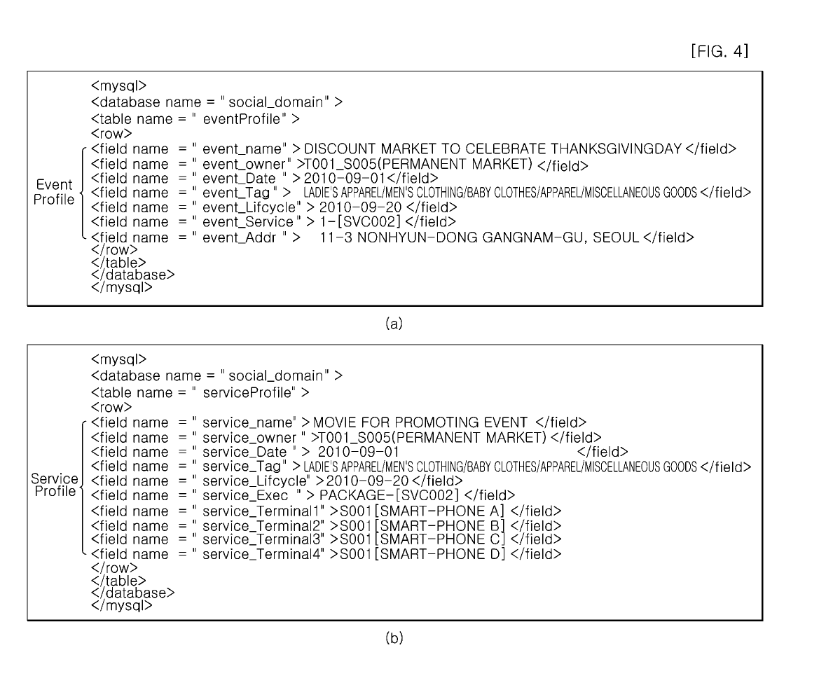

FIG. 4 is a diagram showing a DB schema structure configuring a dynamic radar system for an immediate service based on positions and social relationships. The dynamic radar function for the immediate service collects various information which can be provided at the current location to the user and provides the collected information through the dynamic radar for the user.

FIG. 4A is a structural diagram of an event profile DB schema. This is a data structure in which related information is inputted when various service providers or events are intended to be notified to the user. “event_name/event_owner” displays an event name and a user who registers the event name, and “event_type” displays a classification system code number. This grants an associated classification system code for each event in order to provide customized information to the user. Of course, a type of a currently registered event may be analyzed through “event_tag”. “event_lifecycle” displays an event activation period. The event is generated and extinguished according to a time cycle. “event_service” represents a service profile code number associated with the displayed event. “event_service” represents whether the immediate service can be provided in association with the known event. A service associated with the known event to the user is present, it is verified whether the service is used according to the user terminal, and various packages capable of executing the service are downloaded and installed so as to provide the immediate execution environment.

FIG. 4B is a structural diagram of a service profile DB schema providing an immediate service execution environment. A management function of the service execution environment 340 downloads and installs various package information and package information required for each terminal according to a method determined from the profile. In the terminal, various execution modules required to drive the service are installed to activate contents to be provided. “service_eventCode” coincides with code “event_service” shown in FIG. 4A to provide a predetermined service to the user through the event. Further, whether a provided service is a moving picture, an image, or an application is defined through “service_type” and the execution environment is configured by installing the corresponding package in the terminal through “service_Exec”. Services to be provided to the user are installed as different packages according to the terminal characteristic. Since the packages to be installed are driven in only a predetermined terminal by “service_Terminal”, it is checked whether the service is executable by analyzing the user's terminal information. Since the immediate service execution environment itself is installed and operated through middleware of the terminal, services which are provided for a predetermined time are automatically deleted by “service_livecycle” to prevent resources from being wasted. The immediate service execution environment supports a method in which the user receives the service and event through a predetermined application store provided from a provider and a method in which various users register their own services and events and provide a user who wants to receive the service and event for a desired time. Through such a method, the user may receive an event and a service provided according to the location at a desired location at a desired time and the service and event are automatically extinguished according to the lifecycles of the service and the event. Therefore, the service and event are not required to be additionally managed.

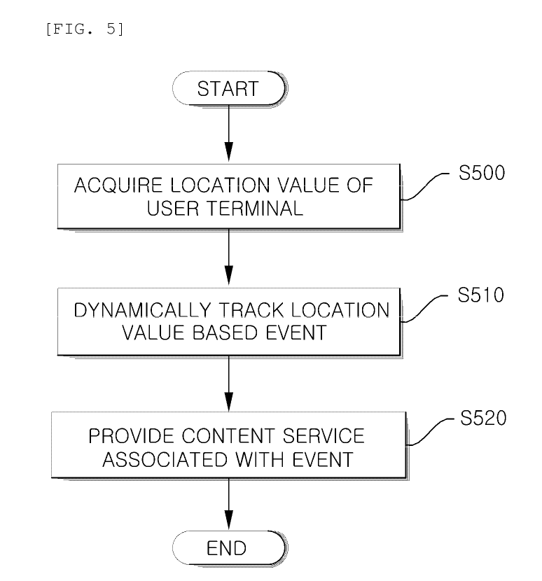

Next, a contents service providing method of the contents service providing apparatus 100 will be described. FIG. 5 is a flowchart showing a contents service providing method according to an exemplary embodiment of the present invention. The following description refers to FIG. 5.

First, a current location value of a user terminal which a user accesses is acquired (a location acquiring step: S500).

Thereafter, events based on the acquired location value are dynamically tracked (an event tracking step: S510). The event tracking step (S510) may include an event extracting step and an event transmitting step. In the event extracting step, whenever the location value is acquired, events associated with a location determined by the acquired location value are extracted. In the event transmitting step, the extracted events are transmitted in real time to a user terminal associated with the acquired location value.

Thereafter, a contents service associated with an event selected among the tracked events is provided (a contents service providing step: S520). The contents service providing step (S520) may include an event selecting step, an access information processing step, a first determination step, a second determination step, a user terminal analyzing step, an execution environment processing step, and the like. In the event selecting step, a predetermined is selected among the tracked events by user input. In the access information processing step, access information of the user terminal is transmitted to a provider's server which registers the selected event. In the first determination step, it is determined whether a content associated with the selected event is present. In the second determination step, in the case in which the content associated with the selected event is present, when information regarding the event is provided to the user terminal by the provider server, whether the contents service is provided on the basis of user input depending on the provided information is determined. In the user terminal analyzing step, in the case when the contents service is provided, the user terminal is analyzed. In the execution environment processing step, when the user terminal is analyzed as a terminal which can execute the service, information regarding the service execution environment is transmitted to the user terminal at the time of transmitting the contents service.

A shared information generating step may be performed before the location acquiring step (S500). In the shared information generating step, execution environment sharing information for sharing an execution environment of the contents service is generated on the basis of a profile defining the execution environment for each contents service. In this case, in the contents service providing step (S520), the execution environment sharing information associated with the corresponding contents service may be together provided at the time of providing the contents service. Since the sharing information is generally generated at the time when the event is registered, the shared information generating step may be performed before the location acquiring step (S500), but is not necessarily limited thereto in the exemplary embodiment.

A shared information determining step may be performed between the event tracking step (S510) and the contents service providing step (S520). In the shared information determining step, one piece of execution environment sharing information is determined on the basis of information regarding the user terminal or information regarding the service environment when execution environment sharing information associated with the corresponding contents service is at least two.

Meanwhile, in the location acquiring step (S500), location values of interested-party terminals accessed by interested parties having the social relationship with the user may be additionally acquired. In consideration of this point, an interested party extracting step and a community service providing step may be performed after the contents service providing step (S520). In the interested party extracting step, interested parties positioned within a predetermined distance from the user are extracted on the basis of the location values of the interested-party terminals. In the community service providing step, a community service with which the extracted interested parties and the user are commonly associated is provided.

An event registering step of registering the event may further be included before the location acquiring step (S500). The event registering step may include an event registration request processing step, an event registration information generating step, a service registration judging step, a registration step, and the like. In the event registration request processing step, an event registration request is received from a provider computer which the provider accesses. In the event registration information generating step, event registration information for registering events is requested to the provider computer when the event registration request is received and thereafter, when the event registration information by the request is received, the received event registration information is generated in an event profile format. In the service registration judging step, whether a contents service to be registered simultaneously is present is inquired at the time of registering the events is present and whether the contents service is registered is judged on the basis of a reply to the inquiry. In the registration step, the event is registered so as to be dynamically tracked on the basis of the generated event registration information. Meanwhile, the event registration step may further include a contents service registration information generating step and a terminal information generating step. In the contents service registration information generating step, in the case in which the contents service to be registered is present, the contents service registration information for registering the contents service is requested to the provider computer and when the contents service registration information by the request is received, the received contents service registration information is generated in a package registration profile format. In the terminal information generating step, terminal information regarding a terminal which can execute the contents service is generated. The contents service registration information generating step and the terminal information generating step may be performed between the service registration judging step and the registration step. In the case in which the event registering step includes the contents service registration information generating step and the terminal information generating step, the event may be registered so as to be dynamically tracked on the basis of the generated contents service registration information and the generated terminal information in the registration step.

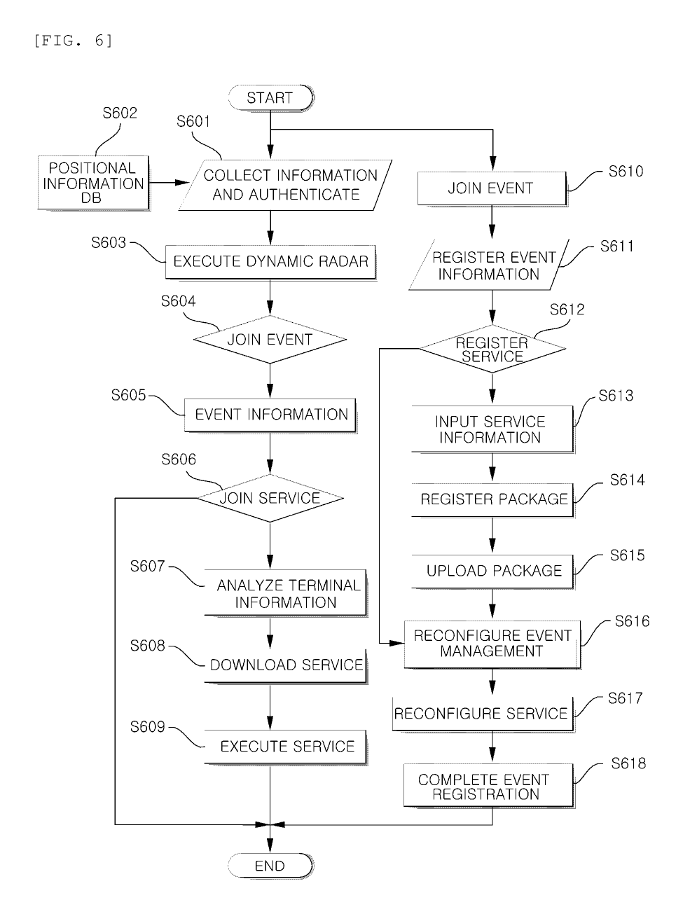

Next, an implementable contents service providing method will be described as an example. FIG. 6 is a flowchart of a dynamic radar system management function for an immediate service based on positions and social relationships. The following description refers to FIG. 6.

When a user is positioned at a predetermined location, personal profile information is updated by collecting the terminal's positional information (S602). After information collection and personal authentication processing (S601), a dynamic radar for providing a service to the user is executed (S603). The dynamic radar outputs necessary information such as a service, an event, a community, and the like around the user as if a radar operates through a user terminal. The user selects a desired event or service through various information displayed on a screen. In this case, the user selects whether to join the event (S604). The user receives information from a user who registers the event through a predetermined event (S605). The user may retrieve various event information around the user through the information and when a content capable of providing the service to the user is judged to be present from the event, it is verified whether the user joins the service (S606). It is verified whether the user joins the service and the user terminal is analyzed (S607). When it is verified that the corresponding terminal is a terminal where the service can be executed, the service is downloaded from a server to configure an execution environment (S608). When the service is downloaded and installed, the user executes the service to receive desired information (S609).

When a provider who intends to register the event is present, an event joining procedure is performed (S610). Information required to join the event is registered through an event profile (S611) and it is verified whether the service is additionally registered (S612). In the case in which the provider does not want to register the service, the added event may be shown through the dynamic radar by executing event management reconfiguration (S616). In the case in which a package is added, package registration profile information is registered (S613) and a package which can be performed in the user terminal is registered (S614).

Thereafter, a software package is uploaded to the server (S615) and information suitable for a terminal which can perform the package is added. The user registers the event and the service and performs the event management reconfiguration (S616) and service reconfiguration (S617) in sequence so as to construct an environment in which various information can be transferred to the user through the dynamic radar (S618).

The present invention can be applied to a social network service (SNS). In particular, the present invention can be applied to a social media service capable of recognizing a positional/social relationship.

The spirit of the present invention has been just exemplified. It will be appreciated by those skilled in the art that various modifications, changes, and substitutions can be made without departing from the essential characteristics of the present invention. Accordingly, the exemplary embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. An apparatus for providing a contents service, comprising:
a location acquiring unit acquiring a current location value of a user terminal accessed by a user;
an event tracking unit dynamically tracking events based on the acquired location value; and
a contents service providing unit providing a contents service associated with an event selected among the tracked events.

2. The apparatus of claim 1, wherein the event tracking unit includes:
an event extracting portion extracting events associated with a location determined by the acquired location value whenever the location value is acquired; and
an event transmitting portion transmitting the extracted events to the user terminal associated with the acquired location value in real time.

3. The apparatus of claim 1, further comprising a shared information generating unit generating execution environment sharing information for sharing an execution environment of the contents service on the basis of a profile defining the execution environment for each contents service,
wherein the contents service providing unit provides the contents service together with the execution environment sharing information associated with the corresponding contents service at the time of providing the contents service.

4. The apparatus of claim 3, further comprising a shared information determining portion determining one piece of execution environment sharing information on the basis of information regarding the user terminal or information regarding the service environment when execution environment sharing information associated with the corresponding contents service is at least two.

5. The apparatus of claim 1, wherein the location acquiring unit additionally acquire location values of interested-party terminals accessed by interested parties having the social relationship with the user and further includes: an interested party extracting unit extracting interested parties positioned within a predetermined distance from the user on the basis of the location values of the interested-party terminals; and a community service providing unit providing a community service with which the extracted interested parties and the user are commonly associated.

6. The apparatus of claim 1, wherein the contents service providing unit includes:
an event selecting portion selecting a predetermined event by user input among the tracked events;
an access information processing portion transmitting access information of the user terminal to a provider server which registers the selected event;
a first determining portion determining whether a content associated with the selected event is present;
a second determining portion determining whether the contents service is provided on the basis of user input depending on the provided information in the case in which the content associated with the selected event is present, when information regarding the event is provided to the user terminal by the provider server;
a user terminal analyzing portion analyzing the user terminal in the case in which the contents service is provided; and
an execution environment processing portion transmitting information regarding the service execution environment to the user terminal at the time of transmitting the contents service when the user terminal is analyzed as a terminal which can execute the service.

7. The apparatus of claim 1, further comprising an event registering unit registering events,
wherein the event registering unit includes:
an event registration request processing portion receiving an event registration request from a provider computer which the provider accesses;
an event registration information generating portion requesting event registration information for registering events to the provider computer when the event registration request is received and generating the received event registration information in an event profile format when the event registration information by the request is received;
a service registration judging portion inquiring whether a contents service to be registered simultaneously at the time of registering the events is present and judging whether the contents service is registered on the basis of a reply to the inquiry; and
a registration portion registering the events so as to be dynamically tracked on the basis of the generated event registration information.

8. The apparatus of claim 7, wherein the event registering unit further includes:
a contents service registration information generating portion requesting the contents service registration information for registering the contents service to the provider computer in the case in which the contents service to be registered is present and generating the received contents service registration information in a package registration profile format when the contents service registration information by the request is received; and
a terminal information generating portion generating terminal information regarding a terminal which can execute the contents service,
wherein the registration portion registers the events so as to be dynamically tracked on the basis of the generated contents service registration information and the generated terminal information.

9. A method for providing a contents service, comprising:
acquiring a current location value of a user terminal accessed by a user;
dynamically tracking events based on the acquired location value; and
providing a contents service associated with an event selected among the tracked events.

10. The method of claim 9, wherein the tracking of the event includes:
extracting events associated with a location determined by the acquired location value whenever the location value is acquired; and
transmitting the extracted events to the user terminal associated with the acquired location value in real time.

11. The method of claim 9, further comprising generating execution environment sharing information for sharing an execution environment of the contents service on the basis of a profile defining the execution environment for each contents service,
wherein in the providing of the contents service, the execution environment sharing information associated with the corresponding contents service is also provided together with the contents service at the time of providing the contents service.

12. The method of claim 11, further comprising determining one piece of execution environment sharing information on the basis of information regarding the user terminal or information regarding the service environment when execution environment sharing information associated with the corresponding contents service is at least two.

13. The method of claim 9, wherein in the acquiring of the location, location values of interested-party terminals accessed by interested parties having the social relationship with the user are additionally acquired and the acquiring of the location further includes: extracting interested parties positioned within a predetermined distance from the user on the basis of the location values of the interested-party terminals; and providing a community service with which the extracted interested parties and the user are commonly associated.

14. The method of claim 9, wherein the providing of the contents service includes:
selecting a predetermined event by user input among the tracked events;
transmitting access information of the user terminal to a provider server which registers the selected event;
determining whether a content associated with the selected event is present;
determining whether the contents service is provided on the basis of user input depending on the provided information in the case in which the content associated with the selected event is present, when information regarding the event is provided to the user terminal by the provider server;
analyzing the user terminal in the case in which the contents service is provided; and
transmitting information regarding the service execution environment to the user terminal at the time of transmitting the contents service when the user terminal is analyzed as a terminal which can execute the service.

15. The method of claim 9, further comprising registering events,
wherein the registering of the events includes:
receiving an event registration request from a provider computer which the provider accesses;
requesting event registration information for registering events to the provider computer when the event registration request is received and generating the received event registration information in an event profile format when the event registration information by the request is received;
inquiring whether a contents service to be registered simultaneously at the time of registering the events is present and judging whether the contents service is registered on the basis of a reply to the inquiry; and
registering the events so as to be dynamically tracked on the basis of the generated event registration information.

16. The method of claim 15, wherein the registering of the events further includes:
requesting the contents service registration information for registering the contents service to the provider computer in the case in which the contents service to be registered is present and generating the received contents service registration information in a package registration profile format when the contents service registration information by the request is received; and
generating terminal information regarding a terminal which can execute the contents service,
wherein in the registering, the events are registered so as to be dynamically tracked on the basis of the generated contents service registration information and the generated terminal information.
